(19) United States
(12) Patent Application Publication
(10) Pub. No.: US 2007/0163166 A1
(43) Pub. Date: Jul. 19, 2007

(54) Fishing weight with swivel, "rock skipper"

(76) Inventors: Wayne Rowe, Oroville, CA (US); John Rowe, Berry Creek, CA (US)

Correspondence Address: Wayne Rowe, 41 Hastie Way, Oroville, CA, 95966, US

(21) Appl. No.: 11/651,659

(22) Filed: Jan. 10, 2007

Related U.S. Application Data
(60) Provisional application No. 60/758,866, filed on Jan. 14, 2006.

(51) Int. Cl. A01K 95/00

(52) U.S. Cl. 43/44.97

(57) ABSTRACT

A round, globe like weight made of alcryn or similar rubber like material with a swivel which is embedded in the body during the injection molding process.

### CROSS-REFERENCE TO RELATED APPLICATIONS

This application claims the benefit of provisional patent application No. 60/758,866, filed 2006 Jan. 14 by the present inventor.

### FEDERALLY SPONSORED RESEARCH

None.

### SEQUENCE LISTING

None.

### BACKGROUND OF THE INVENTION

1. Field of Invention

This invention relates to a fishing weight, specifically to fishing weight, which has no lead in it, right into the material.

2. Prior Art

Fishing in rivers and streams has been a favorite past-time for many people. While I have searched and found no other non-lead fishing weight that is patented, I do know that people have used a lead weight to keep the bait at the bottom of the river or stream so that catching fish which swim close the riverbed/steam bottom would see the bait available and be easier to catch. However, lead weights snag too easily in the rocks and plant life that is on the bottom of the river. This is why I have invented the ‘rock skipper’.

### OBJECTS AND ADVANTAGES

The advantage of the rock skipper is that it is not made from any lead, but instead is made of alcryn or similar type of rubber material with the swivel embedded into the material that allows the fishing weight to ‘skip’ along the bottom of the river and thus, reducing the probability of getting caught in the rocks and thereby causing the fisherman to lose his bait and part of his line. Also, with the swivel embedded in the rubber weight, the fisherman does not need to attach a separate swivel and weight to his/her line. It can be done in one step with the ‘rock skipper’ which is easily attached in one simple step and is available in three different weights.

The swivel lets the weight move and roll. The eye of the swivel embedded into the rubber body holds or attaches the swivel to the rubber making the removal of the swivel from weight very difficult. This is a key element in this weight. No matter the size of the swivel used or the size and weight of rubber used, the concept and functionality of a swivel embedded into a rubber membrane or weight is our claim.

### SUMMARY

The ‘rock skipper’ is a non-lead fishing weight, which is made of a rubber like material, preferably alcryn, which has a swivel embedded right into the material.

### DRAWINGS—FIGURES

FIG. 1 shows a front/side view.

FIG. 2 shows a cross-section view so you can see the bottom half of the swivel embedded into the material when the product is made.

FIG. 3 shows two different or most common ways of attaching the ‘rock skipper to your fishing line.

### DRAWINGS—REFERENCE NUMERALS

1 the body of the ‘rock skipper’ made of alcryn or similar rubber type material
2 swivel, which is embedded right into the material when made

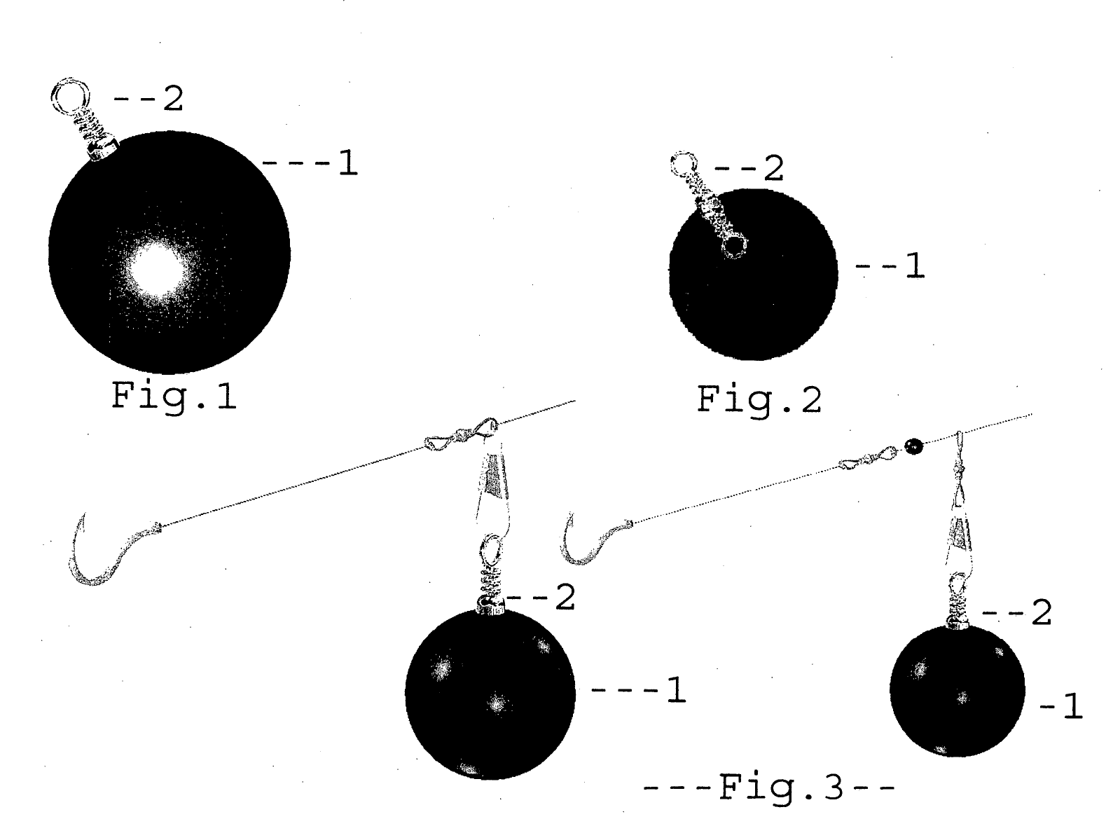

### DETAILED DESCRIPTION—FIGS. 1, 2, 3—PREFERRED EMBODIMENT

FIG. 1 shows a ‘rock skipper’ which consists of the body which is around or globe shaped piece of rubber like material, preferably alcryn, and a swivel, which is embedded into the body when made. The ‘rock skipper’ is made in an injection molding machine with the swivel inserted into the mold so that the alcryn, or similar rubber like material, is molded around it and embeds the swivel keeping it securely in place.

FIG. 2 shows a cross section of the ‘rock skipper so you can see the swivel embedded into the material after it has been injection molded in the injection-molding machine. The ‘rock skipper’ is currently made in three different sizes or weights: 1 ounce, ¾ (0.75) ounce, and ½ (0.5) ounce sizes. They are all globe-like in shape with only the weight being different. The 1 ounce weight has a small, almost unnoticeable protrusion (it looks like a very small dome) on the upper portion of the ‘rock skipper’ close to the swivel so that it can be identified as the largest size made. Other than that differentiating mark, all of the rock skippers look the same. We want to patent the concept of any swivel or device that can swivel into a rubber material. Injection or compression molded or attached into a rubber material in any form.

FIG. 3 shows the two most common ways to attach the ‘rock skipper’ to your fishing line, although it is completely up to the fisherman as to how he would like to attach the ‘rock skipper’ to his line.

Thus the reader will see that the ‘rock skipper’ is indeed a great fishing weight because of its ability to swivel and skip along the bottom of the river or stream without snagging as often as a regular lead weight has been know to do.

1. A fishing weight comprising of:
(a) a piece of alcryn or similar rubber material the shape of a sphere that is used as a weight when fishing and
(b) anti-snag means for preventing said weight from getting caught in the rocks when made with above material and
(c) a swivel made of brass embedded into the body of said weight which is used to attach a fishing line to the weight.
